(19) United States
(12) Patent Application Publication
(10) Pub. No.: US 2007/0007502 A1
(43) Pub. Date: Jan. 11, 2007

(54) End gating terminal for a wire rope safety barrier and wire rope safety barrier equipped with such an end gating terminal

(76) Inventors: Hakan Nilsson, Vastra Frolunda (SE); Mats Heinevik, Vastra Frolunda (SE)

Correspondence Address: KNOBBE MARTENS OLSON & BEAR LLP, 2040 MAIN STREET, FOURTEENTH FLOOR, IRVINE, CA, 92614, US

(21) Appl. No.: 11/177,935

(22) Filed: Jul. 8, 2005

(51) Int. Cl. A01K 3/00

(52) U.S. Cl. 256/13.1

(57) ABSTRACT

The invention refers to an end gating terminal for a wire rope safety barrier of the type comprising a number of spaced apart posts (2,2a), and a number of wire ropes (3) positioned at mutually equal distances one above the other in fittings in the posts, and wherein at the end gating terminal the wire ropes are lead down to and attached to ground anchor (6), and where a last full height post (2a) is positioned at the point where the wire ropes (3) begin to be inclined down towards the ground anchor (6), wherein between the said last full height post (2a) and the ground anchor (6) are provided a number of consecutively shorter posts (2b), in which the wire ropes (3) are held at the same mutual distance as in the portion of the wire rope safety barrier before the inclined portion of the wire ropes, and where the wire ropes (3) from one of the shorter posts (2c) are spread out and being rigidly connected to the ground anchor (6).

### FIELD OF THE INVENTION

The present invention relates to wire rope safety barriers and particularly to end gating terminals for wire rope safety barriers.

### BACKGROUND OF THE INVENTION

Wire rope safety barriers have been in use for several years for fencing off carriageways running in opposite directions on roads and also as side fences between the road and an area directly adjacent the road, and which barriers or fences incorporating a plurality of posts, each one of which are fixed in a concrete foundation spaced apart along the extension of the road. These posts are arranged to support a number of substantially horizontal wire ropes, which are held at a substantially constant mutual spacing along all the posts.

The purpose of these wire rope safety barriers is to prevent vehicles traveling on the road to drive off the road both from the side of the road and also over into the opposed carriage way.

At side road entrances and turnoffs there must of course be an interruption in the wire rope safety barrier, and at these positions there must be an end gating terminal where the ends of the wire ropes are led down to ground level. In earlier embodiments of such end gating terminals these wire ropes have been anchored either together in an earth-based anchor of concrete or another suitable material or individually in a number of terminal posts, whereby the number of terminal posts is equal to the number of wire ropes, and where each individual wire rope is affixed to one of said terminal posts adjacent the position where the terminal post enters into the soil or in its foundation in the soil.

In both these types of end gating terminals the attachments affixing the wire ropes to the anchor or to the terminal posts respectively, are designed in such a manner that they will release the wire ropes, when the end gating terminal is hit by a vehicle independent of if the vehicle hits the end of the end gating terminal at a head on collision or at any angle thereto and also if the wire ropes are hit at a distance from the end gating terminal, and between two consecutive posts.

Tests have shown that both these types of earlier known end gating terminals operate in a fairly satisfactory manner when it comes to causing the vehicle, which has stuck against the wire rope barrier and particularly against an end gating terminal, not to be turned over or thrown over in the opposite carriage way. A drawback is however, that when the wire ropes come loose from the anchor or the terminal posts, this will mean that the wire ropes along the entire section of the wire rope safety barrier, will loose their tension and hang loose. This means that the entire section of the wire rope safety barrier will have no effect for catching a vehicle which is later on hitting the safety barrier, anywhere along the particular section, and this also means that the entire length of the section must be re-tensioned at the same time as new attachments and/or terminal posts are mounted.

The wire ropes of these earlier known end gating terminals will furthermore extend in fan-shape from their anchoring points to the last post after and before the anchoring position, and this means that the distance between the wire ropes are continuously increasing from the first end gating anchor up to the first and following posts having the wire ropes spaced apart at continuous distances. This means that the optimum spacing of the wire ropes at these earlier solutions is not maintained at the inclined portion of the wire ropes.

### SUMMARY OF THE INVENTION

The purpose of the present invention is to propose an improved end gating terminal for a wire rope safety barrier, wherein the drawbacks in the earlier used end gating terminals described hereabove have been eliminated and this has been achieved in that the end gating terminal has been given the features defined in the accompanying claim 1.

The invention also refers to wire rope safety barrier equipped with such an end gating terminal.

### BRIEF DESCRIPTION OF THE DRAWINGS

Hereinafter the invention will be further described with reference to an embodiment of an end gating terminal according to the invention, shown in the accompanying drawing.

FIG. 1 is a view showing schematically an end gating terminal and a section of a wire rope barrier from above, according to the present invention,

FIG. 2 is a schematic side view showing the end gating terminal and the section of a wire rope barrier, according to FIG. 1,

FIG. 3 is a perspective view of parts of a wire anchor fitting,

FIG. 4 is a side view of the wire anchor fitting of FIG. 3 with anchoring rod, and

FIG. 5 is a front view of the wire anchoring fitting shown in FIG. 4.

### DETAILED DESCRIPTION OF THE PREFERRED EMBODIMENT

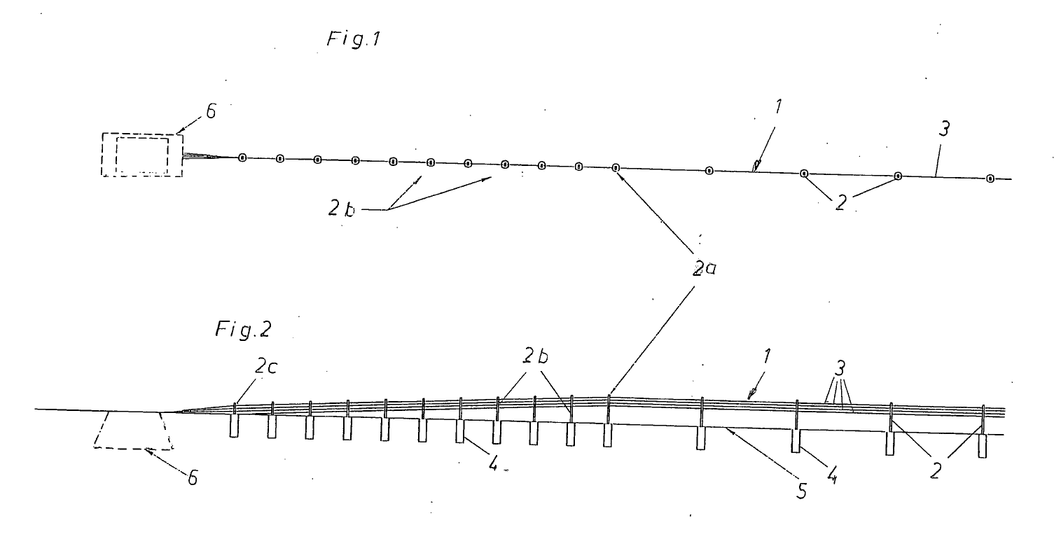

In FIG. 1 is shown from above and schematically a section of a wire rope barrier 1, and it is understood that the section continues further to the right hand side, outside the border of the paper. The wire rope barrier 1 incorporates a number of substantially vertical posts 2, which are arranged with substantially equal spacing and which are of equal height. These posts 2 are in the following referred to as full height posts. Each such full height post supports a number of wire ropes 3, and every full height post 2 is positioned in its own footing 4 embedded in the soil, thus that the footing is in level with the ground 5 (see FIG. 2).

At interruptions in such a sire rope safety barrier the wires 3 have to be anchored in a ground anchor 6 generally comprising a concrete block positioned to be in line with the level of the ground 5, and having embedded therein metallic anchor fittings, which will be further described in connection to FIGS. 3-5. At such an end gating terminal the wire ropes 3 must be lead down to and anchored in the ground anchor 6, which as stated above has earlier been done so that the wire ropes from the last full height post have been spread in fan shape.

In contrast to this, the end gating terminal according to the present invention, between the last full height post 2a and the ground anchor 6, has a series of consecutively shorter posts 2b, which are fitted in footings 4, but which are situated much closer to each other than the full height posts 2, 2a. The adjacent wire ropes 3 are along these consecutively shorter posts 2b, preferably all kept at substantially the same distance from each other as the wire ropes along the full height posts 2, 2a, which means that also the sloping portion of the wire ropes between the last full height post 2a and the ground anchor have a mutual spacing equal to that of the substantially horizontal part of the wire rope safety barrier, whereby the wire ropes along this sloping portion have the same action as the horizontal part of the wire rope barrier. From the last one of the shorter posts 2c, the wire ropes are spread out beside each other in fan shape, to be anchored in the ground anchor 6. With this arrangement, it is ascertained that the shorter posts 2b, when the end gating terminal is hit by a vehicle, will break one after the other, thereby absorbing the forces from the impact, independent of the position where the vehicle hits the wire ropes, and even if the impact is at a position after the last full height post 2a as seen in a direction from the ground anchor. This means that the wire ropes are intact, and it is necessary only to exchange broken shorter posts for new post of appropriate lengths.

In FIG. 3 is shown in perspective how a wire anchor fitting can be constructed. It is understood that the ground anchor 6 (see FIGS. 1 and 2), comprises a big concrete block lowered in the ground and having embedded therein a wire rope anchor fitting 7, consisting of a box-shaped body 8 having at one end a sloping wall 9 with tooth-like notches 10, in each of which a wire rope shall be guided. Each wire rope has end fittings which lie in the tooth-like notches and can therefore not be pulled out by forces acting in the longitudinal direction of the wire rope. However the end fittings could be lift up from the notches and come loose when the wire rope barrier is subjected to a wedging effect if a car hits the wire rope barrier below a wire rope inclined downwards. On the side walls adjacent to the said sloping wall 9 are provided one lug 11 each, having a through-hole for receiving an auxiliary bar 12, which when inserted will prevent the end fittings of the wire ropes to move up above the notches, when it is desired that the wire ropes shall be firmly attached.

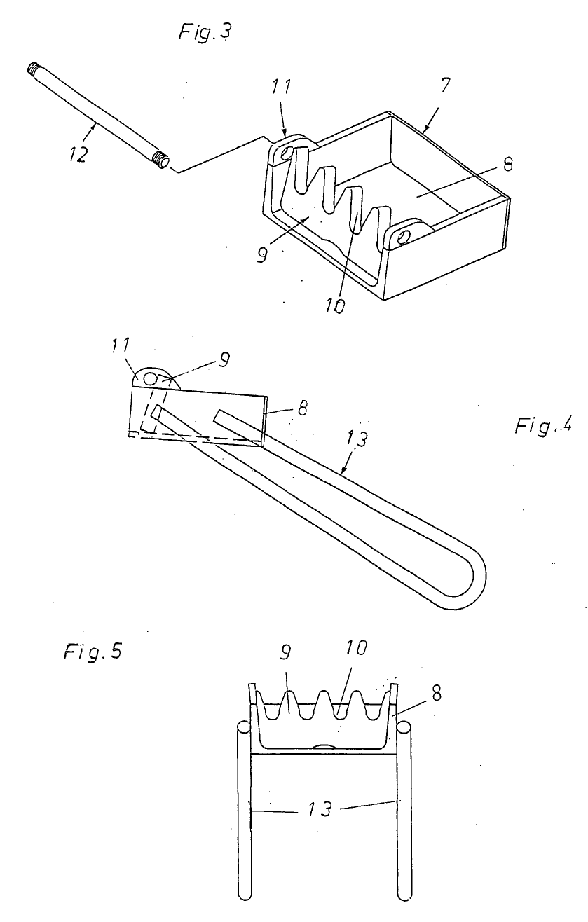

As can be seen in FIGS. 4 and 5 the box shaped body 8 on the sides has anchoring rods 13 for increasing the grip from the concrete.

The invention lies primarily in the arrangement with a number of consecutively shorter posts after the last full height post in the wire rope safety barrier, where the wire ropes in the fittings in the shorter posts have the same mutual spacing as the wire ropes in sections with full height posts.

A further advantage is that the posts to be used can all be of full height, and the posts which shall be shorter can be cut when they shall be positioned in their footings.

The invention is not limited to the embodiment shown in the drawings and described with reference thereto, but modifications and variants are possible within the scope of the following claims.

1-4. (canceled)

5. An end gating terminal for a wire rope safety barrier of the type comprising a number of spaced apart posts and a number of wire ropes positioned at mutually equal distances one above the other in fittings in the posts, and wherein at the end gating terminal the wire ropes are lead down to and attached to a ground anchor, and where a last full height post is positioned at the point where the wire ropes begin to be inclined down towards the ground anchor, wherein between the said last full height post and the ground anchor are provided a number of consecutively shorter posts, in which the wire ropes are held at substantially the same mutual distance as in the portion of the wire rope safety barrier before the inclined portion of the wire ropes, and further wherein the wire ropes from one of the shorter posts are spread out and are rigidly connected to the ground anchor.

6. An end gating terminal for a wire rope safety barrier as claimed in claim 1, wherein the mutual distance between each pair of the consecutively shorter posts is constant, but is shorter than the space between the full height posts.

7. An end gating terminal for a wire rope safety barrier as claimed in claim 5, wherein the ends of the wire ropes are rigidly connected to a wire rope anchor fitting embedded in a concrete block forming the said ground anchor, and where the wire ropes are connected to the anchor fitting side by side.

8. An end gating terminal for a wire rope safety barrier as claimed in claim 6, wherein the ends of the wire ropes are rigidly connected to a wire rope anchor fitting embedded in a concrete block forming the said ground anchor, and where the wire ropes are connected to the anchor fitting side by side.

9. An end gating terminal for a wire rope safety barrier as claimed in claim 1, wherein the wire ropes are spread out from the last one of the shorter posts.

10. A wire rope safety barrier equipped with an end gating terminal as defined in claim 5.

11. A wire rope safety barrier equipped with an end gating terminal as defined in claim 6.

12. A wire rope safety barrier equipped with an end gating terminal as defined in claim 7.

13. A wire rope safety barrier equipped with an end gating terminal as defined in claim 8.

14. A wire rope safety barrier equipped with an end gating terminal as defined in claim 9.
